(19) United States
(12) Patent Application Publication
(10) Pub. No.: US 2007/0058717 A1
(43) Pub. Date: Mar. 15, 2007

(54) Enhanced processing for scanning video

(75) Inventors: Andrew J. Chosak, Arlington, VA (US); Paul C. Brewer, Arlington, VA (US); Geoffrey Egnal, Washington, DC (US); Himaanshu Gupta, Herndon, VA (US); Niels Haering, Reston, VA (US); Alan J. Lipton, Herndon, VA (US); Li Yu, Herndon, VA (US)

Correspondence Address: VENABLE LLP, P.O. BOX 34385, WASHINGTON, DC, 20043-9998, US

(73) Assignee: ObjectVideo, Inc., Reston, VA (US)

(21) Appl. No.: 11/222,233

(22) Filed: Sep. 9, 2005

(51) Int. Cl. H04N 7/12

(52) U.S. Cl. 375/240.08; 375/240.12; 375/240.26

(57) ABSTRACT

A method of video processing may include registering one or more frames of input video received from a sensing unit, where the sensing unit may be capable of operating in a scanning mode. The registration process may project the frames onto a common reference. The method may further include maintaining a scene model corresponding to the sensing unit's field of view. The method may also include processing the registered frames using the scene model, where the result of processing the registered frames includes visualization of at least one result of processing.

### FIELD OF THE INVENTION

The present invention is related to methods and systems for performing video-based surveillance. More specifically, the invention is related to sensing devices (e.g., video cameras) and associated processing algorithms that may be used in such systems.

### BACKGROUND OF THE INVENTION

Many businesses and other facilities, such as banks, stores, airports, etc., make use of security systems. Among such systems are video-based systems, in which a sensing device, like a video camera, obtains and records images within its sensory field. For example, a video camera will provide a video record of whatever is within the field-of-view of its lens. Such video images may be monitored by a human operator and/or reviewed later by a human operator. Recent progress has allowed such video images to be monitored also by an automated system, improving detection rates and saving human labor.

One common issue facing designers of such security systems is the tradeoff between the number of sensors used and the effectiveness of each individual sensor. Take, for example, a security system utilizing video cameras to guard a large stretch of site perimeter. On one extreme, few wide-angle cameras can be placed far apart, giving complete coverage of the entire area. This has the benefits of providing a quick view of the entire area being covered and of being inexpensive and easy to manage, but this has the drawback of providing poor video resolution and possibly inadequate detail when observing activities in the scene. On the other extreme, a larger number of narrow-angle cameras can be used to provide greater detail on activities of interest, at the expense of increased complexity and cost. Furthermore, having a large number of cameras, each with a detailed view of a particular area, makes it difficult for system operators to maintain situational awareness over the entire site.

Common systems may also include one or more pan-tilt-zoom (PTZ) sensing devices that can be controlled to scan over wide areas or to switch between wide-angle and narrow-angle fields of view. While these devices can be useful components in a security system, they can also add complexity because they either require human operators for manual control or else they typically scan back and forth without providing an amount of useful information that might otherwise be obtained. If a PTZ camera is given an automated scanning pattern to follow, for example, sweeping back and forth along a perimeter fence line, human operators can easily lose interest and miss events that become harder to distinguish from the video's moving background. Video generated from cameras scanning in this manner can be confusing to watch because of the moving scene content, difficulty in identifying targets of interest, and difficulty in determining where the camera is currently looking if the monitored area contains uniform terrain.

### SUMMARY OF THE INVENTION

Embodiments of the invention include a method, a system, an apparatus, and an article of manufacture for solving the above problems by visually enhancing or transforming video from scanning cameras. Such embodiments may include computer vision techniques to automatically determine camera motion from moving video, maintain a scene model of the camera's overall field of view, detect and track moving targets in the scene, detect scene events or target behavior, register scene model components or detected and tracked targets on a map or satellite image, and visualize the results of these techniques through enhanced or transformed video. This technology has applications in a wide range of scenarios.

Embodiments of the invention may include an article of manufacture comprising a machine-accessible medium containing software code, that, when read by a computer, causes the computer to perform a method for enhancement or transformation of scanning camera video comprising the steps of: optionally performing camera motion estimation on the input video; performing frame registration on the input video to project all frames to a common reference; maintaining a scene model of the camera's field of view; optionally detecting foreground regions and targets; optionally tracking targets; optionally performing further analysis on tracked targets to detect target characteristics or behavior; optionally registering scene model components or detected and tracked targets on a map or satellite image, and generating enhanced or transformed output video that includes visualization of the results of previous steps.

A system used in embodiments of the invention may include a computer system including a computer-readable medium having software to operate a computer in accordance with embodiments of the invention.

A system used in embodiments of the invention may include a video visualization system including at least one sensing device capable of being operated in a scanning mode; and a computer system coupled to the sensing device, the computer system including a computer-readable medium having software to operate a computer in accordance with embodiments of the invention; and a monitoring device capable of displaying the enhanced or transformed video generated by the computer system.

An apparatus according to embodiments of the invention may include a computer system including a computer-readable medium having software to operate a computer in accordance with embodiments of the invention.

An apparatus according to embodiments of the invention may include a video visualization system including at least one sensing device capable of being operated in a scanning mode; and a computer system coupled to the sensing device, the computer system including a computer-readable medium having software to operate a computer in accordance with embodiments of the invention; and a monitoring device capable of displaying the enhanced or transformed video generated by the computer system.

Exemplary features of various embodiments of the invention, as well as the structure and operation of various embodiments of the invention, are described below with reference to the accompanying drawings.

### DEFINITIONS

The following definitions are applicable throughout this disclosure, including in the above.

A “video” refers to motion pictures represented in analog and/or digital form. Examples of video include: television, movies, image sequences from a video camera or other observer, and computer-generated image sequences.

A “frame” refers to a particular image or other discrete unit within a video.

An “object” refers to an item of interest in a video. Examples of an object include: a person, a vehicle, an animal, and a physical subject.

A “target” refers to the computer's model of an object. The target is derived from the image processing, and there is a one-to-one correspondence between targets and objects.

“Pan, tilt and zoom” refers to robotic motions that a sensor unit may perform. Panning is the action of a camera rotating sideward about its central axis. Tilting is the action of a camera rotating upward and downward about its central axis. Zooming is the action of a camera lens increasing the magnification, whether by physically changing the optics of the lens, or by digitally enlarging a portion of the image.

An “activity” refers to one or more actions and/or one or more composites of actions of one or more objects. Examples of an activity include: entering; exiting; stopping; moving; raising; lowering; growing; shrinking, stealing, loitering, and leaving an object.

A “location” refers to a space where an activity may occur. A location can be, for example, scene-based or image-based. Examples of a scene-based location include: a public space; a store; a retail space; an office; a warehouse; a hotel room; a hotel lobby; a lobby of a building; a casino; a bus station; a train station; an airport; a port; a bus; a train; an airplane; and a ship. Examples of an image-based location include: a video image; a line in a video image; an area in a video image; a rectangular section of a video image; and a polygonal section of a video image.

An “event” refers to one or more objects engaged in an activity. The event may be referenced with respect to a location and/or a time.

A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “computer-readable medium” (or “machine-accessible medium”) refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.

“Software” refers to prescribed rules to operate a computer. Examples of software include: software; code segments; instructions; computer programs; and programmed logic.

A “computer system” refers to a system having a computer, where the computer comprises a computer-readable medium embodying software to operate the computer.

A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.

A “sensing device” refers to any apparatus for obtaining visual information. Examples include: color and monochrome cameras, video cameras, closed-circuit television (CCTV) cameras, charge-coupled device (CCD) sensors, complementary metal oxide semiconductor (CMOS) sensors, analog and digital cameras, PC cameras, web cameras, infra-red imaging devices, devices that receive visual information over a communications channel or a network for remote processing, and devices that retrieve stored visual information for delayed processing. If not more specifically described, a “camera” refers to any sensing device.

A “monitoring device” refers to any apparatus for displaying visual information, including still images and video sequences. Examples include: television monitors, computer monitors, projectors, devices that transmit visual information over a communications channel or a network for remote playback, and devices that store visual information and then allow for delayed playback. If not more specifically described, a “monitor” refers to any monitoring device.

### BRIEF DESCRIPTION OF THE DRAWINGS

Specific embodiments of the invention will now be described in further detail in conjunction with the attached drawings, in which:

FIG. 1 depicts the action of one or more scanning cameras;

FIG. 2 depicts a conceptual block diagram of the different components of the present method of video enhancement or transformation;

FIG. 3 depicts the conceptual components of the scene model;

FIG. 4 depicts an exemplary composite image of a scanning camera's field of view;

FIG. 5 depicts a conceptual block diagram of a typical method of camera motion estimation;

FIG. 6 depicts a conceptual block diagram of a pyramid approach to camera motion estimation;

FIG. 7 depicts how a pyramid approach to camera motion estimation might be enhanced through use of a background mosaic;

FIG. 8 depicts a conceptual block diagram of a typical method of target detection;

FIG. 9 depicts several exemplary frames for one method of visualization where frames are transformed to a common reference;

FIG. 10 depicts several exemplary frames for another method of visualization where a background mosaic is used as backdrop for transformed frames;

FIG. 11 depicts an exemplary frame for another method of visualization where a camera's field of view is projected onto a satellite image;

FIG. 12 depicts a conceptual block diagram of a system that may be used in implementing some embodiments of the present invention; and

FIG. 13 depicts a conceptual block diagram of a computer system that may be used in implementing some embodiments of the present invention.

### DETAILED DESCRIPTION OF EMBODIMENTS OF THE INVENTION

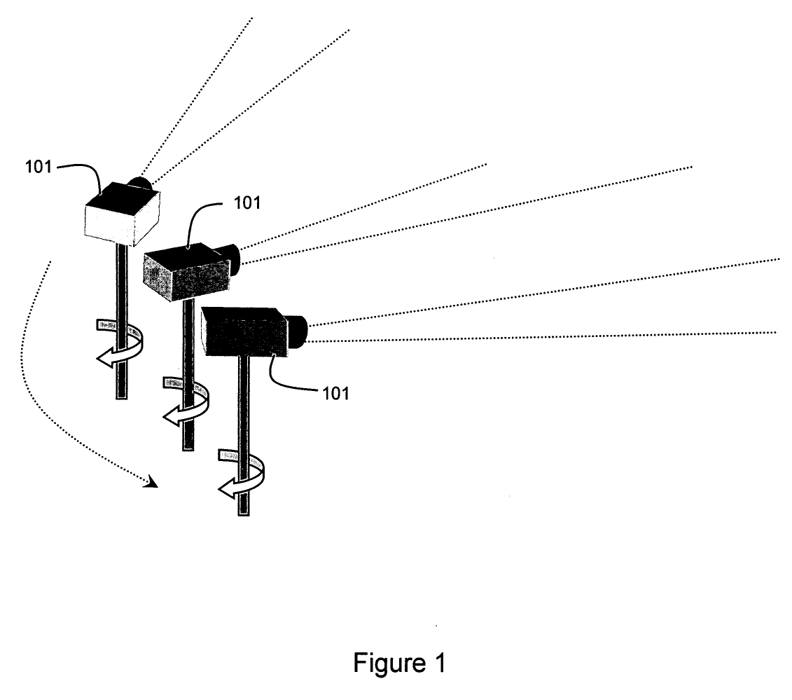

FIG. 1 depicts an exemplary usage of one or more pan-tilt-zoom (PTZ) cameras 101 in a security system. Each of PTZ cameras 101 has been programmed to continuously scan back and forth across a wide area, simply sweeping out the same path over and over. Many commercially available cameras of this nature come with built-in software for setting up these paths, often referred to as “scan paths” or “patterns”.Many third-party camera management software packages also exist to program these devices. Typical camera scan paths might include camera pan, tilt, and zoom. Typical camera scan paths may only take a few seconds to fully iterate, or may take several minutes to complete from start to end.

In many scanning camera security deployments, the programming of scan paths may be independent from the viewing or analysis of their video feeds. One example where this might occur is when a PTZ camera is programmed by a system integrator to have a certain scan path, and the feed from that camera might be constantly viewed or analyzed by completely independent security personnel. Therefore, knowledge of the camera's programmed motion may not be available even if the captured video feed is. Typically, security personnel's interaction with scanning cameras is merely to sit and watch the video feeds as they go by, theoretically looking for events such as security threats.

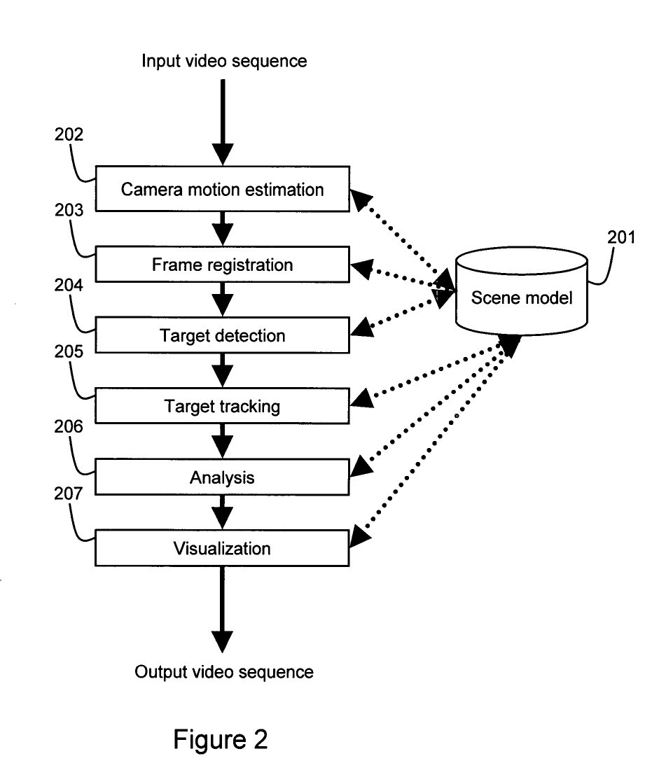

FIG. 2 depicts a conceptual block diagram of the different components of some embodiments of the present method of video enhancement or transformation. Input video from a scanning camera passes through several steps of processing and becomes enhanced or transformed output video. Components of the present method include several algorithmic components that process video as well as modeling components that maintain a scene model that describes the camera's overall field of view.

Scene model 201 describes the field of view of a scanning camera producing an input video sequence. In a scanning video, each frame contains only a small snapshot of the entire scene visible to the camera. The scene model contains descriptive and statistical information about the camera's entire field of view.

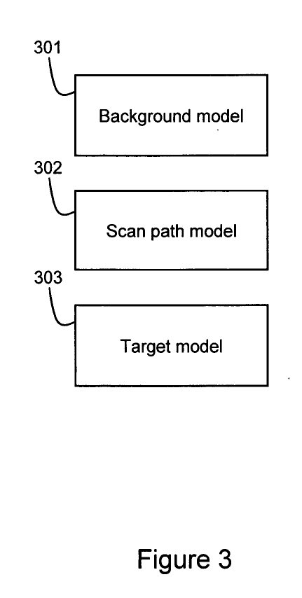

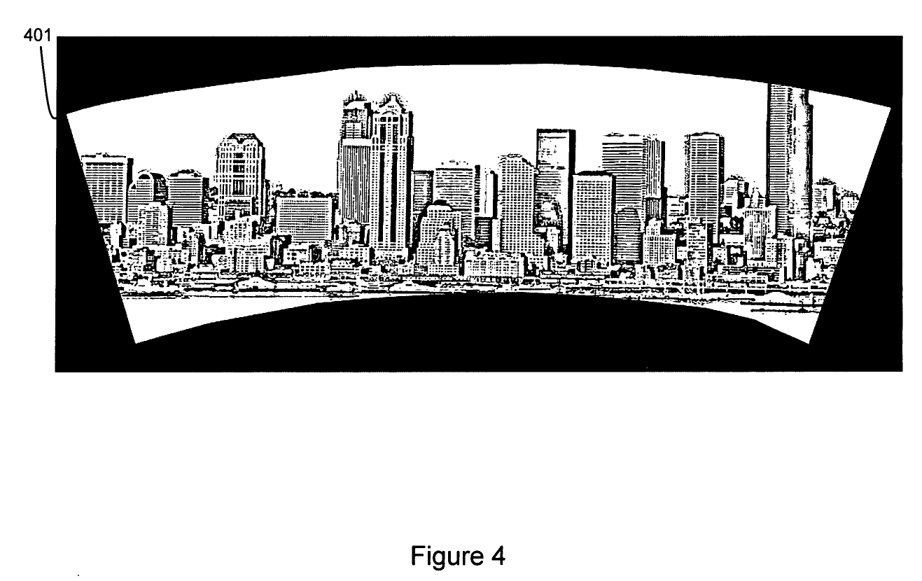

FIG. 3 depicts the conceptual components of the scene model. Background model 301 contains descriptive and statistical information about the visual content of the scene being scanned over. A background model may be as simple as a composite image of the entire field of view. The exemplary image 401 depicted in FIG. 4 shows the field of view of a scanning camera that is simply panning back and forth across a parking lot. A typical technique used to maintain a background model for video from a moving camera is mosaic building, where a large image is built up over time of the entire visible scene. Mosaic images are built up by first aligning a sequence of frames and then merging them together, ideally removing any edge or seam artifacts. Mosaics may be simple planar images, or may be images that have been mapped to other surfaces, for example cylindrical or spherical.

Background model 301 may also contain other statistical information about pixels or regions in the scene. For example, regions of high noise or variance, like water areas or areas containing moving trees, may be identified. Stable image regions may also be identified, for example fixed landmarks like buildings and road markers. Information contained in the background model may be initialized and supplied by some external data source, or may be initialized and then maintained by the algorithms that make up the present method, or may fuse a combination of external and internal data. If information about the area being scanned is known, for example through a satellite image, map, or terrain data, the background model may also model how visible pixels in the camera's field of view relate to that information.

Optional scan path model 302 contains descriptive and statistical information about the camera's scan path. This information may be initialized and supplied by some external data source, such as the camera hardware itself, or may be initialized and then maintained by the algorithms that make up the present method, or may fuse a combination of external and internal data. If the moving camera's scan path consists of a series of tour points that the camera visits in turn, the scan path model may contain a list of these points and associated timing information. If each point along the camera's scan path can be represented by a single camera direction and zoom level, then the scan path model may contain a list of these points. If each point along the camera's scan path can be represented by the four corners of the input video frame at that point when projected onto some common surface, for example, a background mosaic as described above, then the scan path model may contain this information. The scan path model may also contain periodic information about the frequency of the scan, for example, how long it takes for the camera to complete one full scan of its field of view. If information about the area being scanned is known, for example through a satellite image, map, or terrain data, the scan path model may also model how the camera's scan path relates to that information.

Optional target model 303 contains descriptive and statistical information about the targets that are visible in the camera's field of view. This model may, for example, contain information about the types of targets typically found in the camera's field of view. For example, cars may typically be found on a road visible by the camera, but not anywhere else in the scene. Information about typical target sizes, speeds, directions, and other characteristics may also be contained in the target model.

Incoming frames from the input video sequence first go to an optional module 202 for camera motion estimation, which analyzes the frames and determines how the camera was moving when it was generated. If real-time telemetry data is available from the camera itself, it can serve as a guideline or as a replacement for this step. However, such data is either usually not available, not reliable, or comes with a certain amount of delay that makes it unusable for real-time applications.

Camera motion estimation is a process by which the physical orientation and position of a video camera is inferred purely by inspection of that camera's video signal. Depending on the level of detail about the camera motion that is required, different algorithms can be used for this process. For example, if the goal of a process is simply to register all input frames to a common coordinate system, then only the relative motion between frames is needed. This relative motion between frames can be modeled in several different ways, each with increasing complexity. Each model is used to describe how points in one image are transformed to points in another image. In a translational model, the motion between frames is assumed to purely consist of a vertical and/or horizontal shift.
x₂=x₁+Δₓ
y₂=y₁+Δ_{Y} (1)
An affine model extends the potential motion to include translation, rotation, shear, and scale.
x₂=ax₁+by₁+c
y₂=dx₁+ey₁+f (2)
Finally, a perspective projection model fully describes all possible camera motion between two frames.

$${x}_{2} = \frac{{ax}_{1} + {by}_{1} + c}{{gx}_{1} + {hy}_{1} + 1} \\ {y}_{2} = \frac{{dx}_{1} + {ey}_{1} + f}{{gx}_{1} + {hy}_{1} + 1} \qquad ( 3 )$$

Note that all of the three camera motion models above can be represented as a three-by-three matrix with differing degrees of freedom represented by the number of unknown parameters (two, six, and eight, respectively). The tradeoffs one faces in choosing among these models are increasing accuracy of the resulting model at the cost of more parameters to estimate, and the resulting risk of failure. The goal of camera motion estimation is to determine these parameters by visual inspection of the video frames.

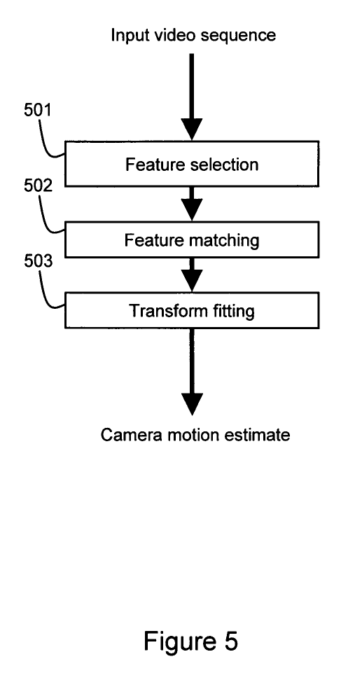

FIG. 5 depicts a conceptual block diagram of a typical method of camera motion estimation. Traditional camera motion estimation usually proceeds in three steps: finding features, matching corresponding features, and fitting a transform to these correspondences. Typically, point features are used, represented by a neighborhood (window) of pixels in the image.

First, in block 501, feature points are found in one or both of a pair of frames under consideration. Not all pixels in a pair of images are well conditioned for neighborhood matching; for example, those near straight edges, in regions of low texture or on jump boundaries may not be well-suited to this purpose. Comer features are usually considered the most suitable for robust matching, and several well-established algorithms exist to locate these features in an image. Simpler algorithms that find edges or high values in a Laplacian image also provide excellent information and consume even fewer computational resources. Obviously, if a scene doesn't contain many good feature points, it will be harder to estimate accurate camera motion from that scene. Other criteria for selecting good feature points may be whether they are located on regions of high variance in the scene or whether they are close to or on top of moving foreground objects.

Next, in block 502, feature points are matched between frames in order to form correspondences. Again, there are a variety of techniques which are commonly used for this step. In an image-based feature matching technique, point features for all pixels in a limited search region in the second image are compared with a feature in the first image to find the optimal match. The metric used to measure feature similarity has a huge impact on the performance and cost of this method. Although metrics such as Sum of Absolute Differences (SAD) and Sum of Squared Differences (SSD) are easy to compute, Normalized Cross Correlation (NCC) is usually credited with higher accuracy. The Modified Normalized Cross Correlation (MNCC) metric was also designed to save computation without sacrificing accuracy.

$$MNCC ( X , Y ) = \frac{2 * COV ( X , Y )}{VAR ( X ) + VAR ( Y )} \qquad ( 4 )$$

The choice of feature window size and search region size and location also impacts performance. Large feature windows improve the uniqueness of features, but also increase the chance of the window spanning a jump boundary. A large search range improves the chance of finding a correct match, especially for large camera motions, but also increases computational expense and the possibility of matching errors.

Once a minimum number of corresponding points are found between frames, they can be fit to a camera model in block 503 by, for example, using a linear least-squares fitting technique. Various iterative techniques such as RANSAC also exist that use a repeating combination of point sampling and estimation to refine the model.

One drawback of the above approach is that computation of the feature-matching metrics described, such as SAD or MNCC, can be quite time-consuming, as they require many mathematical operations. In a typical camera motion estimation algorithm, this step often takes the most time. As a potential way to alleviate this problem, the image frames to be compared may be downsampled first (reduced in spatial resolution) so as to reduce the number of pixels required for each match. Unfortunately, this can reduce the accuracy of the estimate.

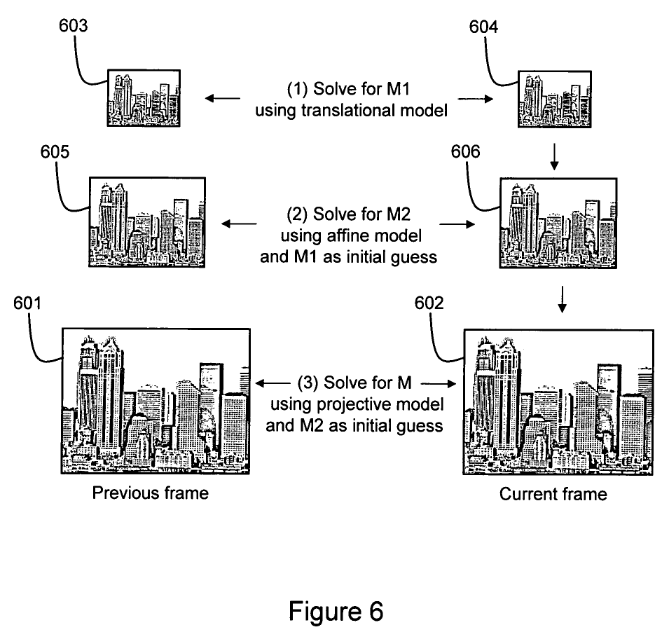

As a compromise, a novel pyramid approach has been developed for use in embodiments of the present invention. FIG. 6 shows a block diagram of this approach, according to some embodiments of the invention. First, the two frames 601, 602 that are to be used are downsampled, resulting in two new images 603, 604. In one exemplary implementation, frames 601, 602 may be downsampled by a factor of four, in which case, the resulting new images 603, 604 would be one-fourth the size of the original images. A translational model may then be used to estimate the camera motion M1 between them. Recall from above that the translational camera model is the simplest representation of possible camera motion.

In the second step of the pyramid approach, two frames 605, 606 that have been downsampled by an intermediate factor from the original images may be used. For efficiency, these frames may be produced during the downsampling process used in the first step. For example, if the downsampling used to produce images 603, 604 was by a factor of four, the downsampling to produce images 605, 606 may be by a factor of two, and this may, e.g., be generated as an intermediate result when performing the downsampling by a factor of four. The translational model from the first step may be used as an initial guess for the camera motion M2 between images 605 and 606 in this step, and an affine camera model may then be used to more precisely estimate the camera motion M2 between these two frames. Note that a slightly more complex model is used at a higher resolution to further register the frames. In the final step of the pyramid approach, a full perspective projection camera model M is found between frames 601, 602 at full resolution. Here, the affine model computed in the second step is used as an initial guess.

The advantage of the pyramid approach is that it reduces computational cost while still ensuring that a complex camera model is used to find a highly accurate estimate for camera motion.

Many other state-of-the-art algorithms exist to perform camera motion estimation. One such technique is described in commonly assigned U.S. patent application Ser. No. 09/609,919, filed Jul. 3, 2000 (which subsequently issued as U.S. Pat. No. 6,738,424), hereafter referred to as Allmen00, and incorporated herein by reference.

Note that module 202 may also make use of scene model 201 if it is available. Many common techniques make use of a background model, such as a mosaic, as a way to aid in camera motion estimation. For example, incoming frames may be matched against a background mosaic which has been maintained over time, removing the effects of noisy frames, lack of feature points, or erroneous correspondences.

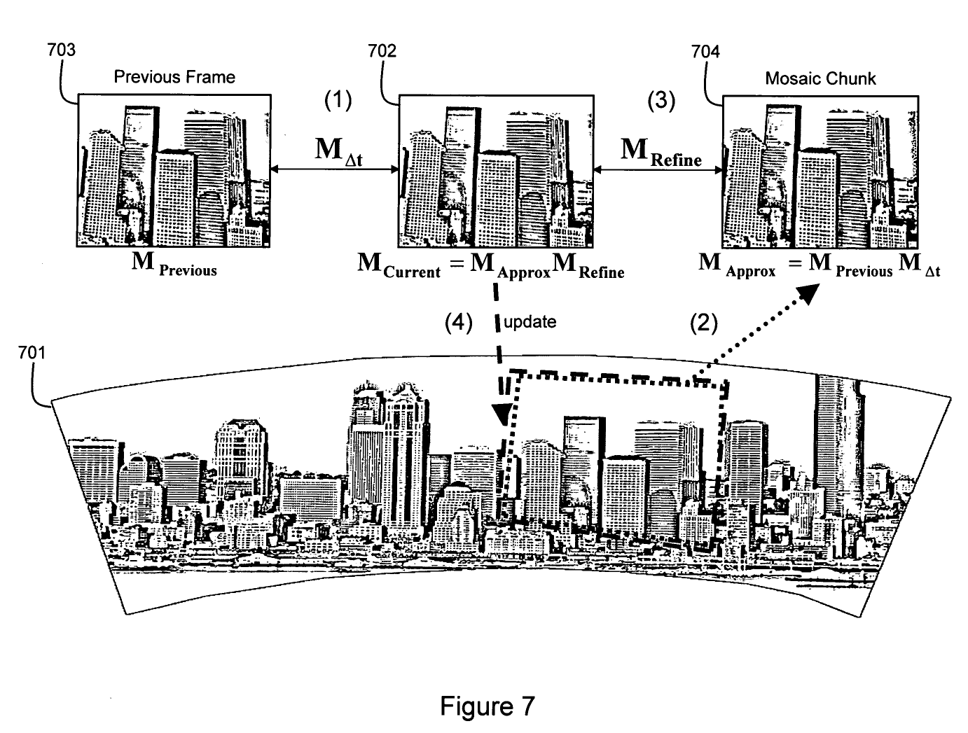

Because mosaic building maintains a scene model of a moving camera's entire field of view, it is a useful tool to improve camera motion estimation. The novel pyramid approach described above for camera motion estimation can also be enhanced by the use of a mosaic. FIG. 7 shows an exemplary block diagram of how this may be implemented, according to some embodiments of the invention. In an exemplary implementation, a planar background mosaic 701 is being maintained, and the projective transforms that map all prior frames into the mosaic are known from previous camera motion estimation. First, a regular frame-to-frame motion estimate M_{Δt} is computed between a new incoming frame 702 and some previous frame 703. A full pyramid estimate can be computed, or only the top two, less-precise layers may be used, because this estimate will be further refined using the mosaic. Next, a frame-sized image “chunk” 704 is extracted from the mosaic by chaining the previous frame's mosaic projection Mₚᵣₑᵥᵢₒᵤₛ and the frame-to-frame estimate M_{Δt}. This chunk represents a good guess Mₐₚₚᵣₒₓ for the area in the mosaic that corresponds to the current frame. Next, a camera motion estimate is computed between the current frame and this mosaic chunk. This estimate, M_{refine}, should be very small in magnitude, and serves as a corrective factor to fix any errors in the frame-to-frame estimate. Because this step is only seeking to find a small correction, only the third, most precise, level of the pyramid technique might be used, to save on computational time and complexity. Finally, the corrective estimate M_{refine} is combined with the guess Mₐₚₚᵣₒₓ to obtain the final result M_{current}. This result is then used to update the mosaic with the current frame, which should now fit precisely where it is supposed to. Note that combining the pyramid technique with the mosaic saves computation and ensures that new frames fit exactly where they should.

Another novel approach that may be used in some embodiments of the present invention is the combination of a scene model mosaic and a statistical background model to aid in feature selection for camera motion estimation. Recall from above that several common techniques may be used to select features for correspondence matching; for example, corner points are often chosen. If a mosaic is maintained that consists of a background model that includes statistics for each pixel, then these statistics can be used to help filter out and select which feature points to use. Statistical information about how stable pixels are can provide good support when choosing them as feature points. For example, if a pixel is in a region of high variance, for example, water or leaves, it should not be chosen, as it is unlikely that it will be able to be matched with a corresponding pixel in another image.

Another novel approach that may be used in some embodiments of the present invention is the reuse of feature points based on knowledge of the scan path model. Because the present invention is based on the use of a scanning camera that repeatedly scans back and forth over the same area, it will periodically go through the same camera motions over time. This introduces the possibility of reusing feature points for camera motion estimation based on knowledge of where the camera currently is along the scan path. A scan path model and/or a background model can be used as a basis for keeping track of which image points were picked by feature selection and which ones were rejected by any iterations in camera motion estimation techniques (e.g., RANSAC). The next time that same position is reached along the scanning path, then feature points which have shown to be useful in the past can be reused. The percentage of old feature points and new feature points can be fixed or can vary, depending on scene content. Reusing old feature points has the benefit of saving computation time looking for them; however, it is valuable to always include some new ones so as to keep an accurate model of scene points over time.

Another novel approach that may be used in some embodiments of the present invention is the reuse of camera motion estimates themselves based on knowledge of the scan path model. Because a scanning camera will cycle through the same motions over time, there will be a periodic repetition which can be detected and recorded. This can be exploited by, for example, using a camera motion estimate found on a previous scan cycle as an initial estimate the next time that same point is reached. If the above pyramid technique is used, this estimate can be used as input to the second, or even third, level of the pyramid, thus saving computation.

Camera motion estimates and the incoming frames that produced them then go to module 203 for frame registration. Once the camera motion has been determined, then the relationship between successive frames is known. This relationship might be described through a camera projection model consisting of an affine or perspective projection. Incoming video frames from a moving camera can then be registered to each other so that differences in the scene (e.g., foreground pixels or moving objects) can be determined without the effects of the camera motion. Successive frames may be registered to each other or may be registered to the background model in scene model 201, which might, for example, be a planar mosaic.

Once the camera motion between two frames has been determined, the second image can be warped to match the first image by applying the computed transformation to each pixel. This process basically involves warping each pixel of one frame into a new coordinate system, so that it lines up with the other frame. Note that frame-to-frame transformations can be chained together so that frames at various points in a sequence can be registered even if their individual projections have not been computed. Camera motion estimates can be filtered over time to remove noise, or techniques such as bundle adjustment can be used to solve for camera motion estimates between numerous frames at once.

Because registered imagery may eventually be used for visualization, it is important to consider appearance of warped frames when choosing a registration surface. Ideally, all frames should be displayed at a viewpoint that reduces distortion as much as possible across the entire sequence. For example, if a camera is simply panning back and forth, then it makes sense for all frames to be projected into the coordinate system of the central frame. Periodic re-projection of frames to reduce distortion may also be necessary when, for example, new areas of the scene become visible or the current projection surface exceeds some size or distortion threshold.

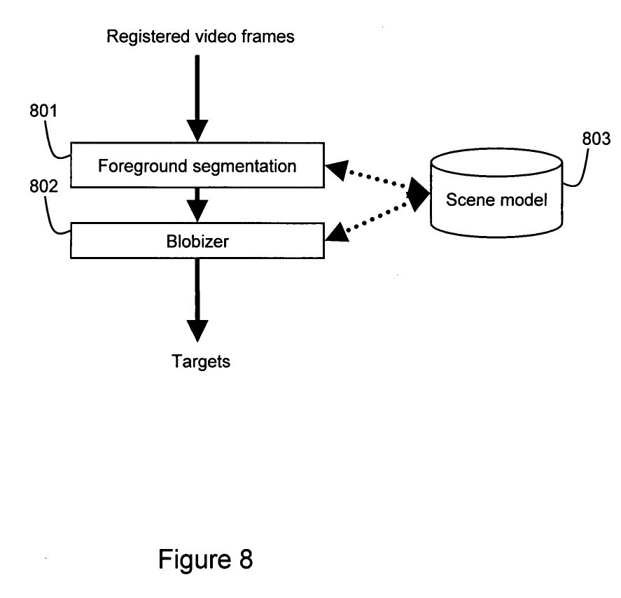

Module 204 detects targets from incoming frames that have been registered to each other or to a background model as described above. FIG. 8 depicts a conceptual block diagram of a method of target detection that may be used in embodiments of the present invention.

Module 801 performs foreground segmentation. This module segments pixels in registered imagery into background and foreground regions. Once incoming frames from a scanning video sequence have been registered to a common reference frame, temporal differences between them can be seen without the bias of camera motion.

A typical problem that camera motion estimation techniques like the ones described above may suffer from is the presence of foreground objects in a scene. For example, choosing correspondence points on a moving target may cause feature matching to fail due to the change in appearance of the target over time. Ideally, feature points should only be chosen in background or non-moving regions of the frames. Another benefit of foreground segmentation is the ability to enhance visualization by highlighting for users what may potentially be interesting events in the scene.

Various common frame segmentation algorithms exist. Motion detection algorithms detect only moving pixels by comparing two or more frames over time. As an example, the three frame differencing technique, discussed in A. Lipton, H. Fujiyoshi, and R. S. Patil, “Moving Target Classification and Tracking from Real-Time Video,” Proc. IEEE WACV '98, Princeton, N.J., 1998, pp. 8-14 (subsequently to be referred to as “Lipton, Fujiyoshi, and Patil”), can be used. Unfortunately, these algorithms will only detect pixels that are moving and are thus associated with moving objects, and may miss other types of foreground pixels. For example, a bag that has been left behind in a scene and is now stationary could still logically be considered foreground for a time after it has been inserted. Motion detection algorithms may also cause false alarms due to misregistration of frames. Change detection algorithms attempt to identify these pixels by looking for changes between incoming frames and some kind of background model, for example, the one contained in scene model 803. Over time, a sequence of frames is analyzed, and a background model is built up that represents the normal state of the scene. When pixels exhibit behavior that deviates from this model, they are identified as foreground. As an example, a stochastic background modeling technique, such as the dynamically adaptive background subtraction techniques described in Lipton, Fujiyoshi, and Patil and in U.S. patent application Ser. No. 09/694,712, filed Oct. 24, 2000, hereafter referred to as Lipton00, and incorporated herein by reference, may be used. A combination of multiple foreground segmentation techniques may also be used to give more robust results.

Foreground segmentation module 801 is followed by a “blobizer” 802. A blobizer groups foreground pixels into coherent blobs corresponding to possible targets. Any technique for generating blobs can be used for this block. For example, the approaches described in Lipton, Fujiyoshi, and Patil may be used. The results of blobizer 802 may be used to update the scene model 803 with information about what regions in the image are determined to be part of coherent foreground blobs. Scene model 803 may also be used to affect the blobization algorithm, for example, by identifying regions of the scene where targets typically appear smaller. Note that this algorithm may also be directly run in a scene model's mosaic coordinate system. In this case, it may take into account perspective distortions that are introduced by the projection of frames onto the mosaic. For example, algorithms that use a distance measurement to determine if two foreground pixels belong to the same blob might need to consider where on the mosaic those pixels are located to determine an appropriate threshold.

The results of foreground segmentation and blobization can be used to update the scene model, for example, if it contains a background model as a mosaic. Various techniques exist to build and maintain mosaics; for example, the technique described in Allmen00 may be used. Building up a mosaic first requires choosing a reference frame or surface upon which to project. Each subsequent frame in the moving camera video sequence is then placed onto the mosaic, eventually overlapping where past frame data has gone. Pixels that have been identified as background when doing foreground segmentation should be used to update the mosaic. A simple technique for doing this involves simply pasting new images on top of the mosaic; this has the drawback of incorporating image edges and discontinuities in places where the camera motion estimate is imprecise or where scene lighting has changed between frames. To attempt to compensate for this, a technique known as “alpha blending” may be used, where a mosaic pixel's new intensity or color is made up of some weighted combination of its old intensity or color and the new image's pixel intensity or color. This weighting may be a fixed percentage of old and new values, or may weight input and output based on the time that has passed between updates. For example, a mosaic pixel which has not been updated in a long time may put a higher weight onto a new incoming pixel value, as its current value is quite out of date. Determination of a weighting scheme may also consider how well the old pixels and new pixels match, for example, by using a cross-correlation metric on the surrounding regions. An even more complex technique of mosaic maintenance involves the integration of statistical information. Here, the mosaic itself is represented as a statistical model of the background and foreground regions of the scene. For example, the technique described in commonly-assigned U.S. patent application Ser. No. 09/815,385, filed Mar. 23, 2001 (issued as U.S. Pat. No. 6,625,310), and incorporated herein by reference, may be used.

Over time, it may become necessary to perform periodic restructuring of the scene model for optimal use. For example, if the scene model consists of a background mosaic that is being used for frame registration, as described above, it might periodically be necessary to re-project it to a more optimal view if one becomes available. Determining when to do this may depend on the scene model, for example, using the scan path model to determine when the camera has completed a full scan of its entire field of view. If information about the scan path is not available, a novel technique may be used in some embodiments of the present invention, which uses the mosaic size as an indication of when a scanning camera has completed its scan path, and uses that as a trigger for mosaic re-projection. Note that when analysis of a moving camera video feed begins, a mosaic must be initialized from a single frame, with no knowledge of the camera's motion. As the camera moves and previously out-of-view regions are exposed, the mosaic will grow in size as new image regions are added to it. Once the camera has stopped seeing new areas, the mosaic size will remain fixed, as all new frames will overlap with previously seen frames. For a camera on a scan path, a mosaic's size will grow only until the camera has finished with its first sweep of an area, and then it will remain fixed. By dynamically increasing the size of the mosaic as it grows, and monitoring when it stops growing, then the point at which a scan path cycle has ended can be detected. This point can be used as a trigger for re-projecting the mosaic onto a new surface, for example, to reduce perspective distortion.

Consider the case where a planar mosaic is used, and the camera starts out panning to the right. Because the first, left-most, frame is used to initialize the mosaic, then each new frame to the right that gets added will be distorted slightly so that it can be registered correctly. Eventually, the right-most frames will be quite distorted, and the mosaic will appear to flare out dramatically to the right. Once the right-most point of the scan path has been reached, as determined by watching the size of the mosaic, the entire mosaic can be re-projected onto a new plane where the central frame in the sequence is used for initialization. This will have the effect of minimizing perspective distortion across all frames and will produce a better mosaic both for visualization as well as for other purposes.

Over time, it may also become necessary to perform periodic enhancement of the scene model for optimal use. For example, if the scene model's background model contains a mosaic that is built up over time by combining many frames, it may eventually become blurry due to small misregistration errors. Periodically cleaning the mosaic may help to remove these errors, for example, using a technique such as the one described in U.S. patent application Ser. No. 10/331,778, filed Dec. 31, 2002, and incorporated herein by reference. Incorporating other image enhancement techniques, such as super-resolution, may also help to improve the accuracy of the background model.

Module 205 performs tracking of targets detected in the scene. This module determines how blobs associate with targets in the scene, and when blobs merge or split to form possible targets. A typical target tracker algorithm will filter and predict target locations based on its input blobs and current knowledge of where targets are. Examples of tracking techniques include Kalman filtering, the CONDENSATION algorithm, a multi-hypothesis Kalman tracker (e.g., as described in W. E. L. Grimson et al., “Using Adaptive Tracking to Classify and Monitor Activities in a Site”,CVPR, 1998, pp. 22-29), and the frame-to-frame tracking technique described in Lipton00. If the scene model contains camera calibration information, then module 205 may also calculate a 3-D position for each target. A technique such as the one described in U.S. patent application Ser. No. 10/705,896, filed Nov. 13, 2003 (published as U.S. Patent Application Publication No. 2005/0104598), and incorporated herein by reference, may also be used. This module may also collect other statistics about targets, such as their speed, direction, and whether or not they are stationary in the scene. This module may also use scene model 201 to help it to track targets, and/or may update the target model contained in scene model 201 with information about the targets being tracked. This target model may be updated with information about common target paths in the scene, using, for example, the technique described in U.S. patent application Ser. No. 10/948,751, filed Sep. 24, 2004, and incorporated herein by reference. This target model may also be updated with information about common target properties in the scene, using for example the technique described in U.S. patent application Ser. No. 10/948,785, filed Sep. 24, 2004, and incorporated herein by reference.

Note that target tracking algorithms may also be run in a scene model's mosaic coordinate system. In this case, then they must take into account the perspective distortions which may be introduced by the projection of frames onto the mosaic. For example, when filtering the speed of a target, its location and direction on the mosaic may need to be considered.

Module 206 performs further analysis of scene contents and tracked targets. This module is optional, and its contents may vary depending on specifications set by users of the present invention. This module may, for example, detect scene events or target characteristics or activity. This module may include algorithms to analyze the behavior of detected and tracked foreground objects. This module makes uses of the various pieces of descriptive and statistical information that are contained in the scene model as well as those generated by previous algorithmic modules.

For example, the camera motion estimation step described above determines camera motion between frames. An algorithm in the analysis module might evaluate these camera motion results and try to, for example, derive the physical pan, tilt, and zoom of the camera. The target detection and tracking modules described above detect and track foreground objects in the scene. Algorithms in the analysis module might analyze these results and try to, for example, detect when targets in the scene exhibit certain specified behavior. For example, positions and trajectories of targets might be examined to determine when they cross virtual tripwires in the scene, using an exemplary technique as described in commonly-assigned, U.S. patent application Ser.No. 09/972,039, filed Nov. 9, 2001 (issued as U.S. Pat. No. 6,696,945), and incorporated herein by reference. The analysis module may also detect targets that deviate from the target model in scene model 201. Similarly, the analysis module might analyze the scene model and use it to derive certain knowledge about the scene, for example, the location of a tide waterline. This might be done using an exemplary technique as described in commonly-assigned U.S. patent application Ser. No. 10/954,479, filed Oct. 1, 2004, and incorporated herein by reference. Similarly, the analysis module might analyze the detected targets themselves, to infer further information about them not computed by previous algorithmic modules. For example, the analysis module might use image and target features to classify targets into different types. A target may be, for example, a human, a vehicle, and animal, or another specific type of object. Classification can be performed by a number of techniques, and examples of such techniques include using a neural network classifier and using a linear discriminant classifier, both of which techniques are described, for example, in Collins, Lipton, Kanade, Fujiyoshi, Duggins, Tsin, Tolliver, Enomoto, and Hasegawa, “A System for Video Surveillance and Monitoring: VSAM Final Report,” Technical Report CMU-RI-TR-00-12, Robotics Institute, Carnegie-Mellon University, May 2000.

All of the above techniques are examples of tasks that might be performed by the analysis module. The analysis module may perform other tasks as well, depending on what information is ultimately required by the downstream visualization module for its tasks. The list given here should not be treated as an exhaustive one.

Module 207 performs visualization and produces enhanced or transformed video based on the input scanning video and the results of all upstream processing, including the scene model. Enhancement of video may include placing overlays on the original video to display information about scene contents, for example, by marking moving targets with a bounding box. Optionally, image data may be further enhanced by using the results of analysis module 206. For example, target bounding boxes may be colored in order to indicate which class of object they belong to (e.g., human, vehicle, animal). Transformation of video may include re-projecting video frames to a different view. For example, image data may be displayed in a manner where each frame has been transformed to a common coordinate system or to fit into a common scene model.

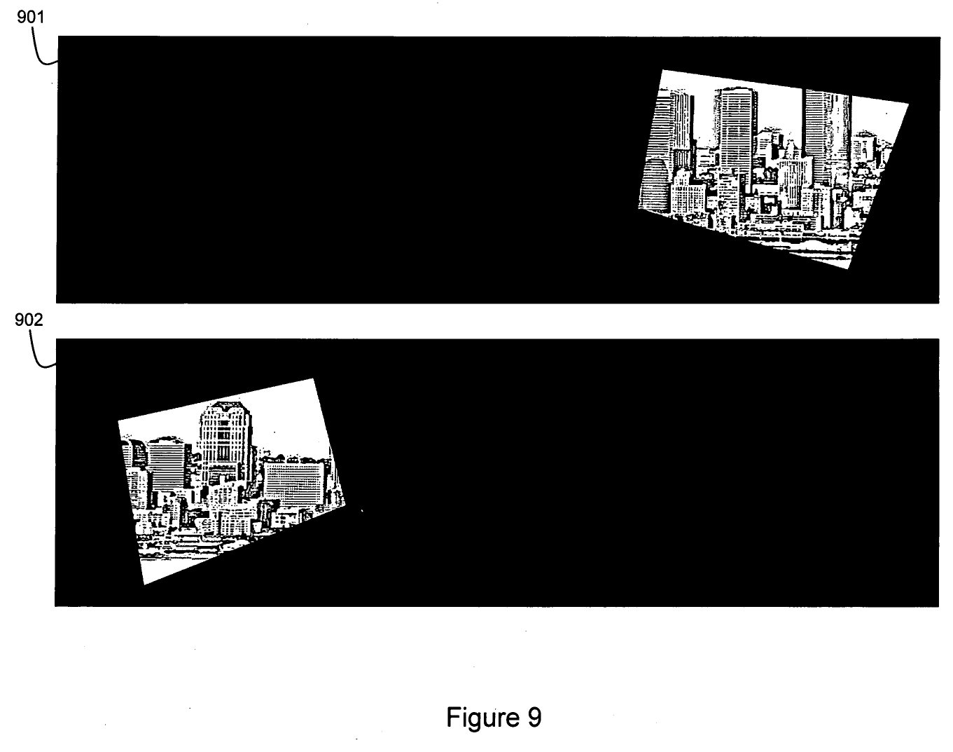

In one implementation, the video signal captured by a scanning PTZ camera is processed and modified to provide the user with an overall view of its scan range, updated in real time with the latest video frames. Each frame in the scanning video sequence is registered to a common reference frame and displayed to the user as it would appear in that reference frame. Older frames might appear dimmed or grayed out based on how old they are, or they might not appear at all. FIG. 9 shows some sample frames 901, 902 from a video sequence that may be generated in this manner. This implementation provides a user of the present invention with a realistic view of not only what the camera is looking at, but roughly where it is looking, without having to first think about the scene. This might be particularly useful if a scanning camera is looking out over uniform terrain, like a field; simply by looking at the original frames from the camera and image capture device, it would not be obvious exactly where the camera was looking. By projecting all frames onto a common reference, it may become instantly obvious where the current frame is relative to all other frames. As another alternative, successive frames can be warped and pasted on top of previous frames that fade out over time, giving a little bit of history to the view.

In another implementation, all frames might be registered to a cylindrical or spherical projection of the camera view.

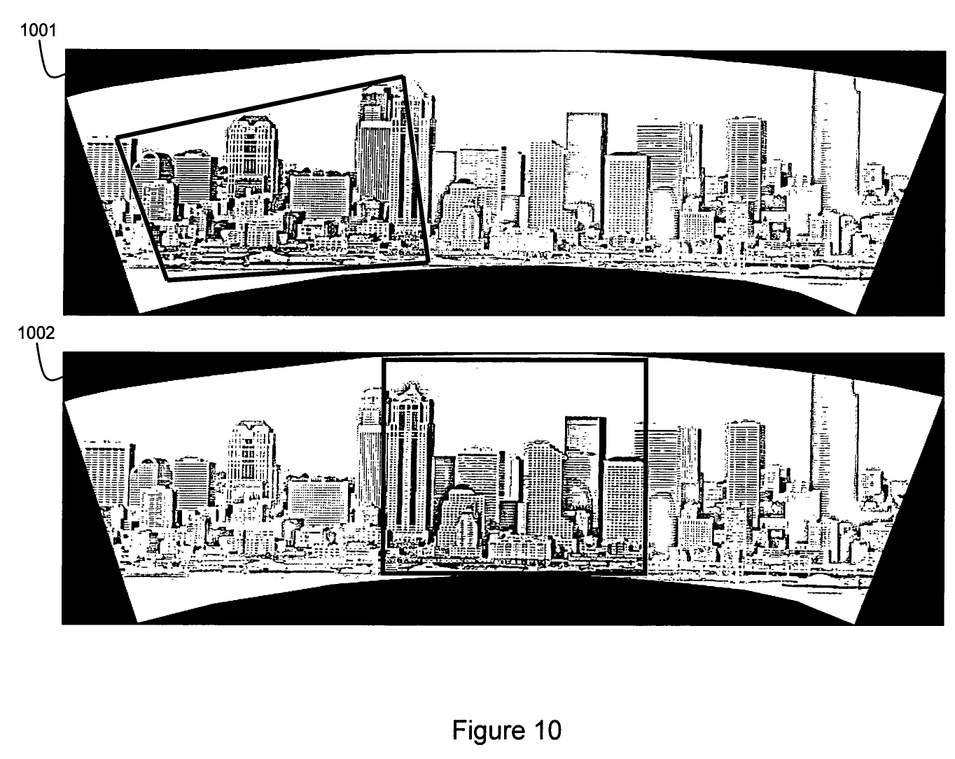

In another implementation, this registered view might be enhanced by displaying a background mosaic image behind the current frame that shows a representation of the entire scene. Portions of this representation might appear dimmed or grayed out based on when they were last visible in the camera view. A bounding box or other marker might be used to highlight the current camera frame. FIG. 10 shows some sample frames 1001, 1002 from a video sequence that may be generated in this manner.

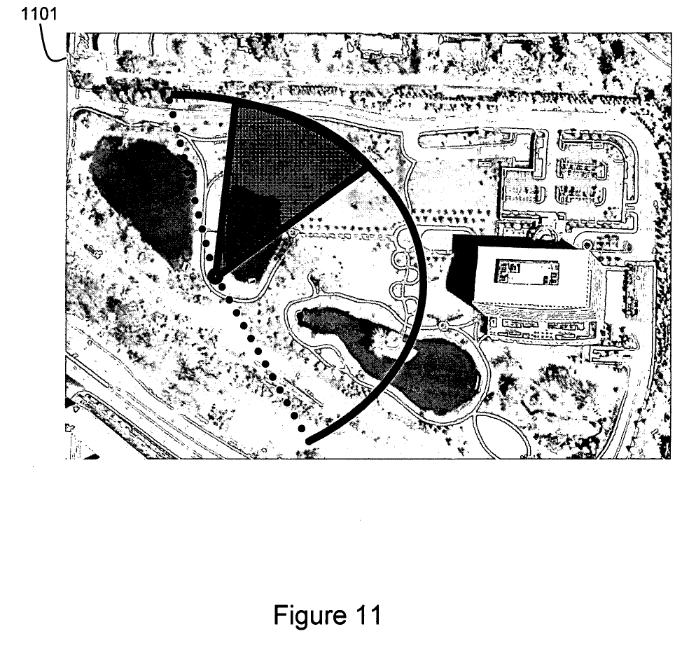

In another implementation of the invention, the video signal from the camera, either unregistered or registered, might be enhanced by the appearance of a map or other graphical representation indicating the current position of the camera along its scan path. The total range of the scan path might be indicated on the map or satellite image, and the current camera field of view might be highlighted. FIG. 11 shows an example frame 1101 showing how this might appear.

In all of the above implementations, visualization of scanning camera video feeds can be further enhanced by incorporating results of the previous vision and analysis modules. For example, video can be enhanced by identifying foreground pixels which have been found using the techniques described above. Foreground pixels may be highlighted, for example, with a special color or by making them brighter. This can be done as an enhancement to the original scanning camera video, to transformed video that has been projected to another reference frame or surface, or to transformed video that has been projected onto a map or satellite image.

Once a scene model has been built up, it can also be used to enhance visualization of moving camera video feeds. For example, it can be displayed as a background image to give a sense of where a current frame comes from in the world. A mosaic image can also be projected onto a satellite image or map to combine video imagery with geo-location information.

Detected and tracked targets of interest may also be used to further enhance video, for example, by marking their locations with icons or by highlighting them with bounding boxes. If the analysis module included algorithms for target classification, these displays can be further customized depending on which class of object the currently visible targets belong to. Targets that are not present in the current frame, but were previously visible when the camera was moving through a different section of its scan path, can be displayed, for example, with more transparent colors, or with some other marker to indicate their current absence from the scene. In another implementation, visualization might also remove all targets from the scene, resulting in a clear view of the scene background. This might be useful in the case where the monitored scene is very busy and often cluttered with activity, and in which an uncluttered view is desired. In another implementation, the timing of visual targets might be altered, for example, by placing two targets in the scene simultaneously even if they originally appeared at different times.

If the analysis module performed processing to detect scene events or target activity, then this information can also be used to enhance visualization. For example, if the analysis module used tide detection algorithms like the one described above, the detected tide region can be highlighted on the generated video. Or, if the analysis module included detection of targets crossing virtual tripwires or entering restricted areas of interest, then these rules can also be indicated on the generated video in some way. Note that this information can be displayed on any of the output video formats described in the various implementations above.

The above implementations are exemplary ways in which scanning camera video might be enhanced with the information gathered in the various algorithmic modules described above. The above list is not exhaustive, and other similar implementations may also be used.

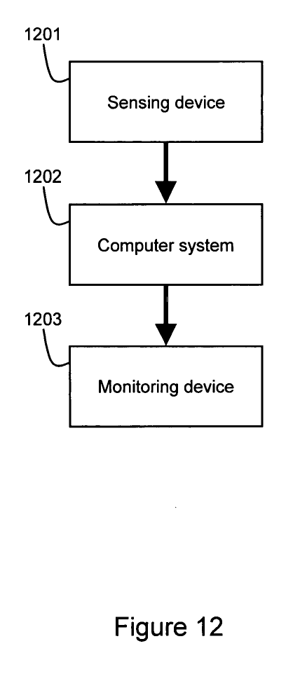

FIG. 12 depicts a block diagram of a system that may be used in implementing some embodiments of the present invention. Sensing device 1201 represents a camera and image capture device capable of obtaining a sequence of video images. This device may comprise any means by which such images may be obtained. Sensing device 201 has means for attaining higher quality images, and may be capable of being panned, tilted, and zoomed and may, for example, be mounted on a platform to enable panning and tilting and be equipped with a zoom lens or digital zoom capability to enable zooming.

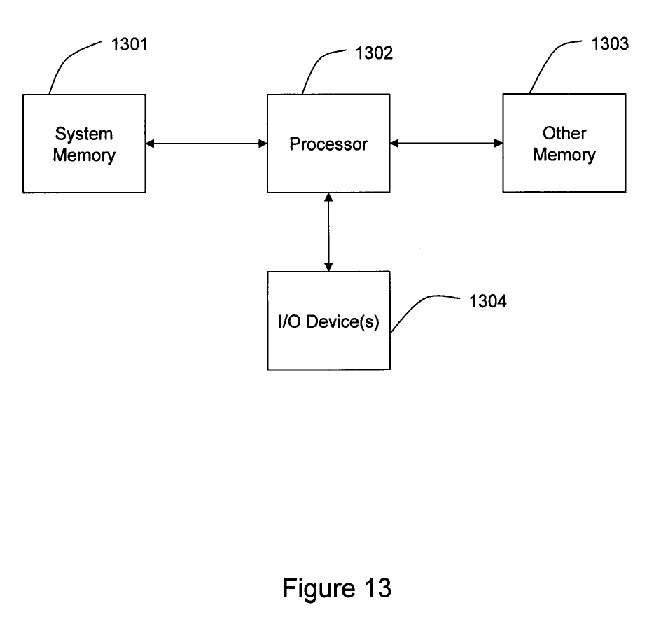

Computer system 1202 represents a device that includes a computer-readable medium having software to operate a computer in accordance with embodiments of the invention. A conceptual block diagram of such a device is illustrated in FIG. 13. The computer system of FIG. 13 may include at least one processor 1302, with associated system memory 1301, which may store, for example, operating system software and the like. The system may further include additional memory 1303, which may, for example, include software instructions to perform various applications. The system may also include one or more input/output (I/O) devices 1304, for example (but not limited to), keyboard, mouse, trackball, printer, display, network connection, etc. The present invention may be embodied as software instructions that may be stored in system memory 1301 or in additional memory 1303. Such software instructions may also be stored in removable or remote media (for example, but not limited to, compact disks, floppy disks, etc.), which may be read through an I/O device 1304 (for example, but not limited to, a floppy disk drive). Furthermore, the software instructions may also be transmitted to the computer system via an I/O device 1304 for example, a network connection; in such a case, a signal containing the software instructions may be considered to be a machine-readable medium.

Monitoring device 1203 represents a monitor capable of displaying the enhanced or transformed video generated by the computer system. This device may display video in real-time, may transmit video across a network for remote viewing, or may store video for delayed playback.

The invention is described in detail with respect to various embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

We claim:

1. A method of video processing comprising:
registering one or more frames of input video received from a sensing unit, the sensing unit being capable of operation in a scanning mode, to project the frames onto a common reference and to obtain registered frames of the input video;
maintaining a scene model corresponding to said sensing unit's field of view;
processing said registered frames of said input video to obtain processed video, said processing utilizing said scene model, wherein said processed video includes visualization of at least one result of said processing.

2. The method according to claim 1, further comprising:
estimating motion of said sensing unit.

3. The method according to claim 2, wherein said estimating motion is performed based on real-time telemetry data obtained from the sensing unit.

4. The method according to claim 2, wherein said estimating motion comprises:
using a translational model of motion between video frames.

5. The method according to claim 2, wherein said estimating motion comprises:
using an affine model of motion between video frames.

6. The method according to claim 2, wherein said estimating motion comprises:
using a perspective projection model of motion between video frames.

7. The method according to claim 2, wherein said estimating motion comprises performing at least two of the operations selected from the group consisting of:
using a translational model of motion between video frames;
using an affine model of motion between video frames; and
using a perspective projection model of motion between video frames.

8. The method according to claim 7, wherein said estimating motion further comprises:
downsampling video frames; and
wherein said estimating motion comprises performing at least one of said at least two selected operations upon a first set of downsampled video frames resulting from said downsampling.

9. The method according to claim 8, wherein said estimating motion comprises:
using said translational model of motion between video frames on said first set of downsampled video frames; and
using said affine model of motion between video frames on a second set of downsampled video frames that are downsampled by a factor less than said first set of downsampled video frames.

10. The method according to claim 9, wherein said using said affine model of motion between video frames utilizes as an initial estimate of sensing unit motion a result obtained from said using said translational model of motion between video frames.

11. The method according to claim 9, wherein said estimating motion further comprises:
using said perspective projection model of motion between video frames on the non-downsampled video frames.

12. The method according to claim 11, wherein said using said perspective projection model of motion between video frames utilizes as an initial estimate of sensing unit motion a result obtained from said using said affine model of motion between video frames.

13. The method according to claim 2, wherein said estimating motion of said sensing unit comprises:
computing a frame-to-frame motion estimate based on a current frame and a previous frame;
obtaining an approximation of said current frame by combining a projection of said previous frame onto a background mosaic with said frame-to-frame motion estimate; and
estimating a motion estimate correction based on said current frame and said approximation of said current frame.

14. The method according to claim 2, wherein said scene model includes statistical data about each pixel of a background model, and wherein said estimating motion of said sensing unit comprises choosing at least one reference point using said statistical data.

15. The method according to claim 2, wherein said scene model includes a scan path model, and wherein said estimating motion of said sensing unit comprises:
keeping track of at least one reference point used for estimating motion of said sensing unit; and
reusing at least one reference point previously used in estimating motion of said sensing unit when a position corresponding to said at least one reference point is reached along a scan path of said sensing unit.

16. The method according to claim 2, wherein said estimating motion of said sensing unit comprises:
selecting at least one feature of said input video frames;
matching said at least one feature between frames; and
fitting the results of said matching to a sensing unit model.

17. The method according to claim 1, wherein said scene model comprises:
a background model; and
at least one further model selected from the group consisting of: a scan path model and a target model.

18. The method according to claim 1, further comprising:
detecting at least one target in said video based on said registered frames of said input video.

19. The method according to claim 18, wherein said detecting at least one target comprises:
segmenting said registered frames into foreground and background regions; and
performing blobization on said foreground regions to obtain one or more targets.

20. The method according to claim 19, wherein said segmenting, said performing blobization, or both use said scene model.

21. The method according to claim 19, wherein results of said segmenting, said performing blobization, or both are used to update said scene model.

22. The method according to claim 18, further comprising:
tracking at least one detected target.

23. The method according to claim 1, wherein said processing comprises:
detecting at least one of the group consisting of a scene event, a target characteristic, and a target activity.

24. The method according to claim 23, further comprising:
detecting and tracking at least one target in said video based on said registered frames of said input video; and
wherein said detecting at least one of the group consisting of a scene event, a target characteristic, and a target activity comprises:
analyzing the behavior of said at least one target.

25. The method according to claim 24, wherein said analyzing the behavior comprises:
classifying said at least one target.

26. The method according to claim 1, wherein said visualization includes at least one indication of at least one target in said processed video.

27. The method according to claim 26, wherein said indication comprises a bounding box.

28. The method according to claim 27, wherein said at least one bounding box includes a feature to indicate a characteristic of said at least one target.

29. The method according to claim 26, wherein said indication comprises an icon.

30. The method according to claim 29, wherein said icon includes a feature to indicate a characteristic of said target.

31. The method according to claim 1, wherein said visualization includes at least one indication of aging of video frames in said processed video.

32. The method according to claim 1, wherein said visualization includes at least one indication of a current view of said sensing unit relative to at least a portion of the entire field-of-view of said sensing unit.

33. A machine-accessible medium containing software that when executed by a processor causes said processor to execute the method of video processing according to claim 1.

34. The machine-accessible medium according to claim 33, further containing software that when executed by said processor causes the method to further include:
estimating motion of said sensing unit, wherein said registering uses a result of said estimating motion; and
detecting and tracking at least one target, wherein said visualization includes at least one indication of said at least one target.

35. The machine-accessible medium according to claim 33, wherein said visualization includes at least one indication of a current view of said sensing unit relative to at least a portion of the entire field-of-view of said sensing unit.

36. A method of estimating motion of a sensing unit based on video frames provided by said sensing unit, the method comprising performing at least two of the operations selected from the group consisting of:
using a translational model of motion between video frames;
using an affine model of motion between video frames; and
using a perspective projection model of motion between video frames.

37. The method according to claim 36, wherein said estimating motion further comprises:
downsampling video frames; and
wherein said estimating motion comprises performing at least one of said at least two selected operations upon a first set of downsampled video frames resulting from said downsampling.

38. The method according to claim 37, wherein said estimating motion comprises:
using said translational model of motion between video frames on said first set of downsampled video frames; and
using said affine model of motion between video frames on a second set of downsampled video frames that are downsampled by a factor less than said first set of downsampled video frames.

39. The method according to claim 38, wherein said using said affine model of motion between video frames utilizes as an initial estimate of sensing unit motion a result obtained from said using said translational model of motion between video frames.

40. The method according to claim 38, wherein said estimating motion further comprises:
using said perspective projection model of motion between video frames on the non-downsampled video frames.

41. The method according to claim 40, wherein said using said perspective projection model of motion between video frames utilizes as an initial estimate of sensing unit motion a result obtained from said using said affine model of motion between video frames.

42. The method according to claim 36, further comprising:
computing a frame-to-frame motion estimate based on a current frame and a previous frame;
obtaining an approximation of said current frame by combining a projection of said previous frame onto a background mosaic with said frame-to-frame motion estimate; and
estimating a motion estimate correction based on said current frame and said approximation of said current frame.

43. The method according to claim 36, further comprising choosing at least one reference point using statistical data about each pixel of a background model.

44. The method according to claim 36, further comprising:
keeping track of at least one reference point used for estimating motion of said sensing unit; and
reusing at least one reference point previously used in estimating motion of said sensing unit when a position corresponding to said at least one reference point is reached along a scan path of said sensing unit.

45. The method according to claim 36, further comprising:
selecting at least one feature of said input video frames;
matching said at least one feature between frames; and
fitting the results of said matching to a sensing unit model.

46. A video processing system comprising:
at least one sensing device to be operated in a scanning mode;
a video processor coupled to said at least one scanning device to receive video frames from said at least one sensing device, the video processor to register said video frames, to maintain at least one scene model corresponding to said video frames, and to process said video frames based on said at least one scene model; and
a monitoring device coupled to said video processor, wherein said video processor visualizes at least one result of processing said video frames on said monitoring device.

47. The video processing system according to claim 46, wherein said monitoring device is to perform at least one of the tasks selected from the group consisting of:
displaying video in real-time;
transmitting video across a network to enable remote viewing; and
storing video to enable delayed playback.

48. The video processing system according to claim 46, wherein said sensing device comprises means for increasing an image quality obtained by said sensing device.
